(19) United States
(12) Patent Application Publication
(10) Pub. No.: US 2014/0305535 A1
(43) Pub. Date: Oct. 16, 2014

(54) Reinforced Liners for Pipelines

(71) Applicants: Timothy D. Anderson, Houston, TX (US); Mohan Kulkarni, The Woodlands, TX (US); Stefan J. Glen, Walkerton, IN (US); Matthew E. Sexton, Hartford, MI (US); Elson B. Fish, Lakeville, IN (US); Michelle A. Fiwek, Plymouth, IN (US); Scott R. Farrisee, South Bend, IN (US)

(72) Inventors: Timothy D. Anderson, Houston, TX (US); Mohan Kulkarni, The Woodlands, TX (US); Stefan J. Glen, Walkerton, IN (US); Matthew E. Sexton, Hartford, MI (US); Elson B. Fish, Lakeville, IN (US); Michelle A. Fiwek, Plymouth, IN (US); Scott R. Farrisee, South Bend, IN (US)

(21) Appl. No.: 14/245,758

(22) Filed: Apr. 4, 2014

Related U.S. Application Data
(60) Provisional application No. 61/811,504, filed on Apr. 12, 2013.

(51) Int. Cl. F16L 58/00; B29C 47/06; F16L 9/128

(52) U.S. Cl. CPC F16L 58/00; F16L 9/128; B29C 47/065
USPC 138/173; 264/162; 264/167

(57) ABSTRACT

A reinforced pipeline liner designed to facilitate installation and systems and methods for producing and installing a reinforced pipeline liner. A reinforced pipeline liner can comprise a body portion having a layer of matrix material, the layer having an inner surface and an outer surface, and a plurality of interspersed reinforcement structures embedded within the body portion. The reinforcement structures are positioned between the inner surface and outer surface of the layer and circumferentially offset from the other reinforcement structures. Additionally, the body portion may have multiple thicknesses.

### CROSS REFERENCE TO RELATED APPLICATIONS

This application claims the benefit of U.S. Provisional No. 61/811,504, filed Apr. 12, 2013 and is incorporated by reference herein in its entirety.

### FIELD OF THE INVENTION

The subject innovation relates to the field of pipeline liners and, more particularly, to a reinforced pipeline liner designed to facilitate installation.

### BACKGROUND

This section is intended to introduce various aspects of the art, which may be associated with embodiments of the disclosed techniques. This discussion is believed to assist in providing a framework to facilitate a better understanding of particular aspects of the disclosed techniques. Accordingly, it should be understood that this section is to be read in this light, and not necessarily as admissions of prior art.

Most pipelines used for the transportation of oil, gas, water, or mixtures of these fluids, are constructed from carbon steel. Carbon steel is a desirable material due to its availability, low cost relative to other materials, strength, toughness and ability to be welded. However, carbon steels can be corroded by many of the fluids contacting them. Almost all carbon steel pipelines have some level of corrosion of their internal surface and large costs are expended in the monitoring of corrosion, injecting chemicals into the pipeline to inhibit corrosion, and inspection of the pipeline.

Even with these mitigating activities, significant corrosion can occur, causing reduction of the pipe wall thickness, typically in uneven channels or pits. The corrosion can extend along long segments of a pipeline or may be only in localized areas. Furthermore, the corrosion may grow through the pipeline wall resulting in small leaks. These leaks are typically repaired by applying an external clamp around the pipeline. At times the corrosion can be so extensive that external clamps are ineffective and segments of the pipeline are replaced at high cost, often causing long term deferred production of hydrocarbons.

Pipeline liners have been used to provide a barrier against the deleterious effects of internal corrosion on pipelines. The plastic materials of the pipeline liners are placed in direct contact with the transported fluids instead of the steel pipeline. The liners exhibit superior corrosion resistance, yet provide a cost-effective alternative to pipeline replacement or the use of corrosion-resistant alloys. Additionally, remediation of a deteriorated pipeline with a pipeline liner can allow restoration of the full pressure rating of the pipe.

The market for liners is mature to the point that several competing technologies are available. Several types of liners are intended for use in the water-transport and sanitation markets, providing short-length rehabilitation within the pipeline. The vast networks of pipelines in the oil and gas industry have facilitated the development of several long distance pipeline liner options.

Types of long distance pipeline liners include thermoplastic liners and composite liners. Both thermoplastic and composite liners provide corrosion resistance when installed, but the variations in mechanical properties make each of them attractive for particular applications.

Thermoplastic liners, which are the more simple form of pipeline liners, are composed entirely of polymeric, or plastic, material. The most commonly used polymer in pipeline liner applications is High-Density Polyethylene (HDPE), due to its low cost, availability, and range of service conditions. Alternative plastics may also be selected for their enhanced strength or high-temperature service capabilities. These thermoplastic materials have excellent formability and advantageous material properties. Thermoplastic liners are generally not strong enough to withstand long pull lengths or independently withstand the full range of operating pressures prevalent in the hydrocarbon production industry.

Thermoplastic feedstock can easily be extruded into continuous tubular forms. Precise dimensional control allows the liner to conform to the host pipe. The pipeline liner can be reeled for delivery if it has a small diameter, or the liner segments can be fusion welded on-site. Insertion of the liner, or slip-lining, often necessitates that the plastic liner have a temporary size reduction in order to easily traverse within the host pipeline.

Thermoplastic properties allow several options for this size reduction, including roller reduction and folding of the tube into a smaller diameter. In service, the host pipe is still relied upon for pressure containment, but the strength of thermoplastics does allow bridging of small gaps, pits, or pinholes. However, the relatively low range of mechanical strength properties of thermoplastic liners does impose other limitations. The low longitudinal strength limits the pulling length, as the liner will tear under its own weight and the frictional drag that arises during slip-lining. It also limits the available host pipe geometries; typical minimum bend radii are on the order of 50 pipe diameters.

Composite liners are another major category of pipeline liners. Composite liners have been developed to expand the range of conditions in which liners may be applied. The cost of composite liners may prohibit their use in remediation projects if the full extent of their properties is not necessary, such as a short pipe that is still capable of pressure containment.

Currently available composite liners are manufactured in a multi-step process in which successive layers are wrapped around a plastic core pipe. In this way, the corrosion resistance of thermoplastics can be combined with the mechanical properties afforded by reinforcing materials such as glass fiber, metallic cables or wires, carbon fiber, ultra-high molecular weight polyethylene (UHMWPE), or nylon. The complexity of these systems necessitates more tooling and results in a greater cost per unit length over plastic liners, but the superior mechanical properties grant the tubing sufficient hoop strength for pressure-containment. In many cases, the host pipe only serves as a conduit for running the composite liner, which then acts as a self-sufficient pipeline. Many composite liners available in the market today were initially designed as stand-alone flexible pipe. The complex fabrication of these composites typically requires that they be manufactured in a facility and then delivered to the installation site on a spool. The size of spools which can be delivered onshore can limit composite liners to small (<6″) diameters.

Like thermoplastic liners, composite pipe liners are installed via slip-lining. The high strength properties allow much longer insertions. The high strength also permits composite liners to negotiate sharper bends in the host pipe. Some known composite liners permit a minimum bend radius as low as nine (9) pipe diameters.

One specific known composite pipeline liners employs an inner HDPE pipe wrapped in various layers of reinforcement. This liner was originally conceived to overcome some of the challenges inherent in the lining process by fabricating the composite in the field. The portable factory removes the length limitations that reeling imposes on length (up to 10 miles), and allows for significantly larger diameter pipelines to be lined. In general, existing liner technologies have not been shown to overcome the issue of severe bends (three to five diameters) in the host pipeline.

Thus, there is a need for improvement in this field.

### SUMMARY

Embodiments of the present disclosure provide a pipeline liner designed to facilitate installation. Other embodiments relate to systems and methods for producing and installing a reinforced pipeline liner.

One embodiment of the present disclosure is a reinforced pipeline liner comprising a body portion having a layer of matrix material, the layer having an inner surface and an outer surface, wherein the body portion has a longitudinal dimension; and a plurality of interspersed reinforcement structures embedded within the body portion, each reinforcement structure is positioned between the inner surface and outer surface of the layer and circumferentially offset from the other reinforcement structures, each reinforcement is aligned parallel to the longitudinal dimension.

The foregoing has broadly outlined the features of one embodiment of the present disclosure in order that the detailed description that follows may be better understood. Additional features and embodiments will also be described herein.

### DESCRIPTION OF THE DRAWINGS

The present innovation and its advantages will be better understood by referring to the following detailed description and the attached drawings.

FIG. 1 is a diagram showing a system of providing a liner for a pipe according to one embodiment of the present disclosure.

FIG. 2 is a diagram showing a system for providing a liner for a pipe using fiber pultrusion according to one embodiment of the present disclosure.

FIG. 3 is a diagram showing a system for providing a liner for a pipe using long-fiber co-extrusion according to one embodiment of the present disclosure.

FIG. 4 is a diagram showing a system for providing a liner for a pipe using tape pultrusion according to one embodiment of the present disclosure.

FIG. 5 is a cross-section of a pipeline liner produced via tape pultrusion according to one embodiment of the present disclosure.

FIG. 6 is a cross-section of a pipeline liner as known in the prior art.

FIG. 7 is a cross-section of a pipeline liner in a folded configuration as known in the prior art.

FIG. 8 is a cross-section of a pipeline liner and a host pipe as known in the prior art.

FIG. 9 is a cross-section of a pipeline liner in a folded configuration according to one embodiment of the present disclosure.

FIG. 10 is a partial cross-section of a pipeline liner according to one embodiment of the present disclosure.

FIG. 11 is a cross-section of a pipeline liner according to one embodiment of the present disclosure.

It should be noted that the figures are merely examples of several embodiments of the present invention and no limitations on the scope of the present invention are intended thereby. Further, the figures are generally not drawn to scale, but are drafted for purposes of convenience and clarity in illustrating various aspects of certain embodiments of the invention.

### DETAILED DESCRIPTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. Some embodiments of the invention are shown in great detail, although it will be apparent to those skilled in the relevant art that some features that are not relevant to the present invention may not be shown for the sake of clarity.

To the extent a term used herein is not defined below, it should be given the broadest definition persons in the pertinent art have given that term as reflected in at least one printed publication or issued patent.

The present disclosure describes systems and methods for inserting a polymeric liner into an existing pipeline to separate corrosive fluid running through the inside of the pipeline from the inside wall of the pipeline in order to prevent or reduce further corrosion. The liner may bridge small holes in the steel pipeline wall, thus stopping small leaks. In addition, a liner according to embodiments of the present disclosure may be installed in older pipelines that have corrosion damage, or in new pipelines to prevent corrosion damage. It is desirable for the pipeline to have sufficient structural strength to support the lining.

There are many possible applications for liners that necessitate properties beyond that of thermoplastics but do not demand the elevated properties or cost of composites. A simplified form of composite that provides the service characteristics of a thermoplastic with the installation options possible with current composites would greatly expand the opportunities for liners in the marketplace. Reinforcing materials may be used to attain greater pull lengths and to overcome tight bends in the host pipe that restrict current liner installation. In service, however, a liner according to embodiments of the present disclosure has properties similar to a thermoplastic by providing a barrier against further corrosive attack on the host pipe. In this way, a liner according to embodiments of the present disclosure may improve performance/cost ratio relative to known technologies. Further cost-savings may be available by incorporating matrix material and reinforcement material into a liner in a single manufacturing step, thus reducing the necessary tooling, footprint, and manpower.

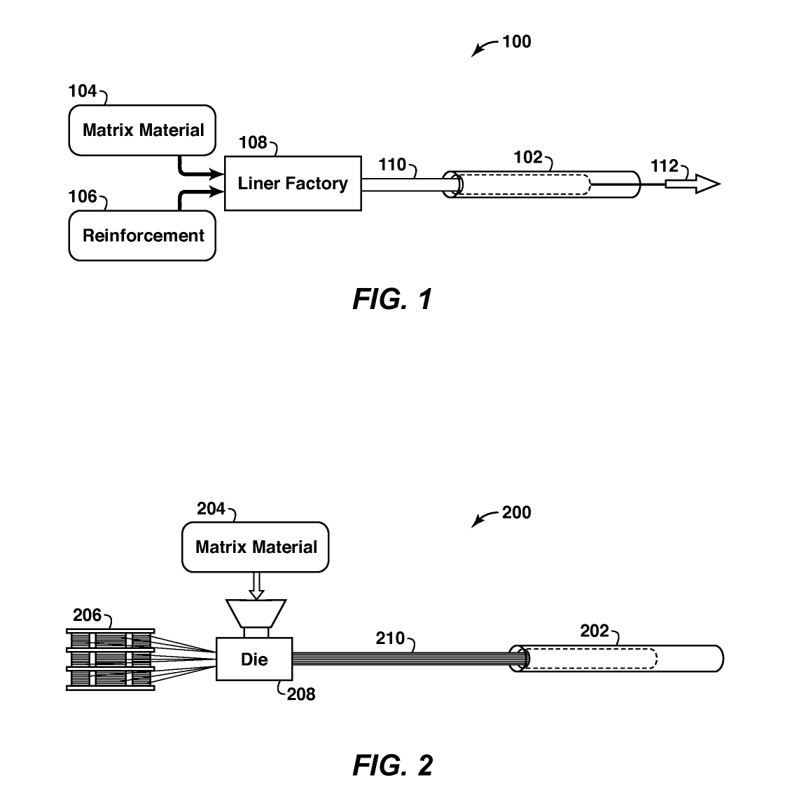

FIG. 1 is a diagram showing a system 100 of providing a liner for a host pipe 102 according to an embodiment of the present disclosure. A matrix material source 104 provides matrix material to the liner manufacturing equipment, herein referred to as the liner factory 108. Simultaneously, a reinforcement material source 106 provides reinforcement material to the liner factory 108. As explained herein, the liner factory 108 combines matrix material from the matrix material source 104 with reinforcement material from the reinforcement material source 106 to produce a pipeline liner 110.

As explained herein, the pipeline liner 110 may comprise a body portion produced from the matrix material. The pipeline liner 110 additionally comprises a reinforcing structure produced from the reinforcement material. The liner factory 108 is an example of a device that simultaneously receives the material to form the body portion of the liner (the matrix material) and the material to form the reinforcement structure (the reinforcement material) in the liner. The liner factory 108 then produces the body of the liner with the reinforcement structure interspersed within the body of the liner in a continuous single-step process.

In the example shown in FIG. 1, the pipeline liner 110 may be pulled through an existing host pipe 102 by a pulling device 112 as it is produced. In this manner, the matrix material and the reinforcement material needed to produce the pipeline liner 110 may be efficiently transported to the site of the host pipe 102. Moreover, the pipeline liner 110 may be produced in one manufacturing operation at the site of the host pipe 102.

According to embodiments of the present disclosure, the pipeline liner 110 provides a cost-effective lining for a long-distance pipeline for the purpose of remediation. An exemplary embodiment combines desirable attributes of thermoplastic and composite liners described herein in order to maximize the longitudinal strength of the liner with a single-step manufacturing process. The pipeline liner 110, which is a composite liner, is produced in a manner similar to a plastic pipe or liner, but reinforcement material is simultaneously included in the same process.

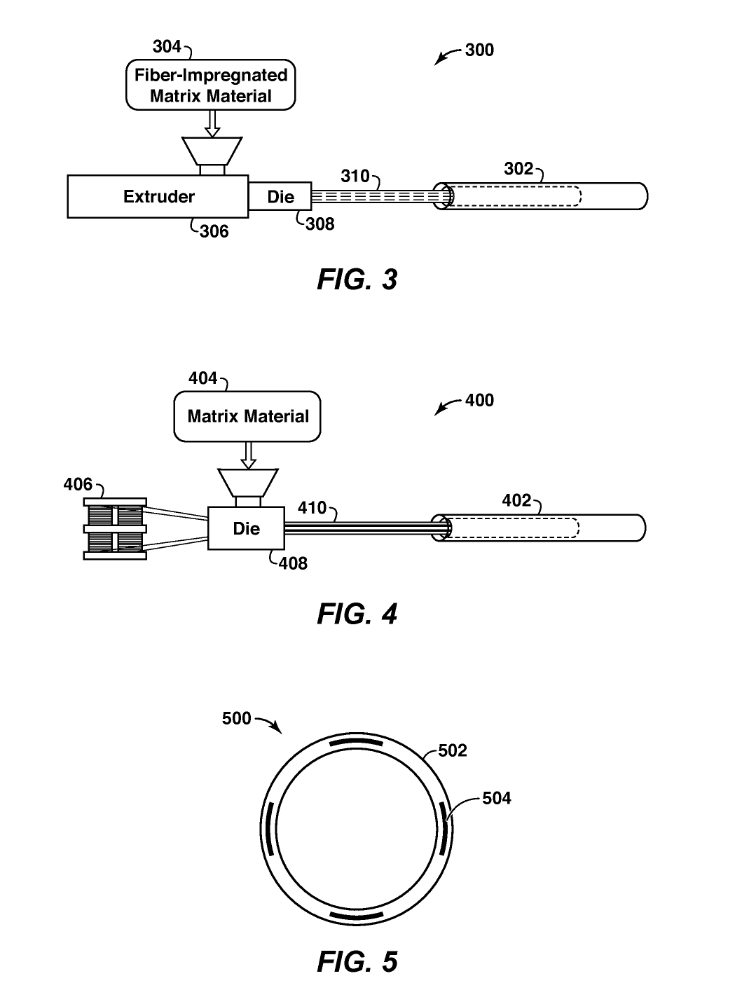

FIGS. 2-4 provide specific examples of different fabrication techniques that may be employed according to embodiments of the present disclosure. The examples shown in FIG. 2 (pultrusion) and FIG. 3 (co-extrusion) promote longitudinal orientation for the reinforcing material, which maximizes its contribution to the tensile strength of the liner. Efficient use of the reinforcing material is an advantageous aspect of the design of the pipeline liner of embodiments of the present disclosure, as the cost of reinforcing material can be several times greater than the composite matrix material. The large increase in tensile strength caused by reinforcing materials permits longer pulling distances, as the pipeline liner can now withstand more frictional drag during slip-lining installation. One example of reinforcing material that may be used is fiber. Examples of material types that may be used to provide fiber reinforcement according to embodiments of the present disclosure include glass fiber, metallic cables or wires, carbon fiber, ultra-high molecular weight polyethylene (UHMWPE), and nylon, among others. However, pre-preg tapes or strips composed in part by these materials could also be used to confer axial strength during installation, as described herein with reference to the example shown in FIG. 4.

A pipeline liner according to embodiments of the present disclosure may provide advantages relative to known pipeline liners. First, the longer pulling distance reduces the number of incursions that are typically made when remediating long-distance pipelines. Because greater distances can now be lined in a single slip-lining operation, more pipelines than ever before could be amenable to remediation by lining. For instance, some pipelines can no longer be accessed easily because of structures and/or populations that have since accumulated over them. The improved tensile strength of the pipeline liner of embodiments of the present disclosure would increase the range of pipeline geometries open to slip-lining, since a stronger liner could more easily negotiate pipelines with bends in their length.

A single-step manufacturing process according to embodiments of the present disclosure also improves the portability of the process over known composite-type pipeline liners. The use of a portable factory as described herein simplifies the case of in-field fabrication. Space considerations for a long-distance slip-lining operation become difficult if the entire length of liner is to be delivered in whole to the work-site. In-field fabrication according to embodiments of the present disclosure allows for relatively efficient delivery of the raw materials and the factory itself to the work-site, without transporting a completed pipeline liner to the work-site. The continuous manufacturing method also eliminates the necessity of a joining process to produce the long-distance liner.

Like the thermoplastic liners described herein, a pipeline liner according to embodiments of the present disclosure may provide the hoop strength of the host pipeline during service by assuming a tight fit along the inner pipe surface. The use of reinforcements aligned circumferentially in order to impart hoop strength to the liner can therefore be omitted, reducing the overall material cost. However, if the integrity of the host pipeline cannot be assured, embodiments of the present disclosure permit the addition of spirally-wound reinforcements in a subsequent manufacturing step. The pipeline liner would then be lent a pressure-carrying capacity.

FIG. 2 is a diagram showing a system 200 for providing a liner for a pipe using fiber pultrusion according to embodiments of the present disclosure. A matrix material source 204 provides matrix material to a forming die 208. Simultaneously, a number of fiber reels 206 provide fiber reinforcement material to the die 208. As explained herein, the die 208 combines matrix material from the matrix material source 204 with fiber reinforcement material from the fiber reels 206 using a process of fiber pultrusion to produce a pipeline liner 210. The pipeline liner 210 may then be deployed within a host pipe 202, as fully set forth herein.

Carbon fibers are examples of strong fibers that are readily available for use in the system 200. Carbon fibers possess tensile strengths on the order of giga-pascals, which is several orders of magnitude greater than the strength of thermoplastic materials. An exemplary method for using carbon fibers efficiently is to make them continuous along the length of the liner. The pultrusion manufacturing process performed by the system 200 is capable of delivering a tubular composite with continuous fibers. In an exemplary process of pultrusion, fibers are unwound from the fiber reels 206 and passed through a container of liquefied matrix material. The wetted fibers then pass through the forming die 208, which defines the shape of the resultant composite material. Since the fibers are being pulled, they will tend to maintain a longitudinal orientation. The longitudinal orientation of the fibers maximizes their contribution to axial strength, potentially reducing the overall amount of fibers needed and further reducing the material costs.

FIG. 3 is a diagram showing a system 300 for providing a liner for a pipe using long-fiber thermoplastic extrusion (LFT) according to embodiments of the present disclosure. LFT provides a relatively large degree of control over the extrusion process. In this manner, fibers emerge from a die in significantly greater lengths. The tensile strength of the resulting pipeline liner is thus considerably improved.

In the example shown in FIG. 3, a fiber-impregnated matrix material source 304 is delivered to an extruder 306. The extruder 306 delivers processed fiber-impregnated matrix material to a die 308. The die 308 then produces a composite liner 310 that includes fiber reinforcement. The composite liner 310 may be deployed into a host pipe 302 as explained herein.

FIG. 4 is a diagram showing a system 400 for providing a liner for a pipe using tape pultrusion according to embodiments of the present disclosure. A matrix material source 404 provides matrix material to a die 408. Simultaneously, a number of pre-impregnated tape reels 406 provide reinforcement material to the die 408. As explained herein, the die 408 combines matrix material from the matrix material source 404 with reinforcement material from the pre-impregnated tape reels 406 using a process of tape pultrusion to produce a composite pipeline liner 410. The pipeline liner 410 may then be deployed within a host pipe 402, as fully set forth herein.

FIG. 5 is a cross-section of a pipeline liner 500 produced via tape pultrusion according to embodiments of the present disclosure. The pipeline liner 500 comprises a body portion 502 of matrix material. At various points around the circumference of the body portion 502, reinforcement structures 504 in the form of tape elements are deployed. The reinforcement structures 504 provide axial strength for the body portion 502.

Unlike known liner technologies, a pipeline liner according to embodiments of the present disclosure may provide the ability to remediate relatively long-distance pipelines from a single access point using low-cost materials. Such an improvement is useful in the energy industry, which employs pipeline assets of significantly greater scale than, for example, the utility industry.

Embodiments of the axially-reinforced composite liner described herein utilize high-strength reinforcements for the purposes of extending installation lengths within existing pipelines. Unlike existing composite liners, the reinforcing elements are not helically wrapped around the tubular shape, and therefore do not contribute any hoop strength in order to provide pressure containment of the internal transmitted fluids. Under typical designs, the existing hoop strength of the original host pipe is still relied upon for pressure containment. This is often achieved by matching the outer liner diameter to the inner diameter of the pipe. The resulting tight-fitting condition permits the continued use of the hoop strength of the host pipe. The tight-fit condition is achieved by reducing the effective liner diameter prior to insertion. The elastic properties of thermoplastic liners facilitate this process by allowing a temporary size reduction when the material is pulled through a reduced die.

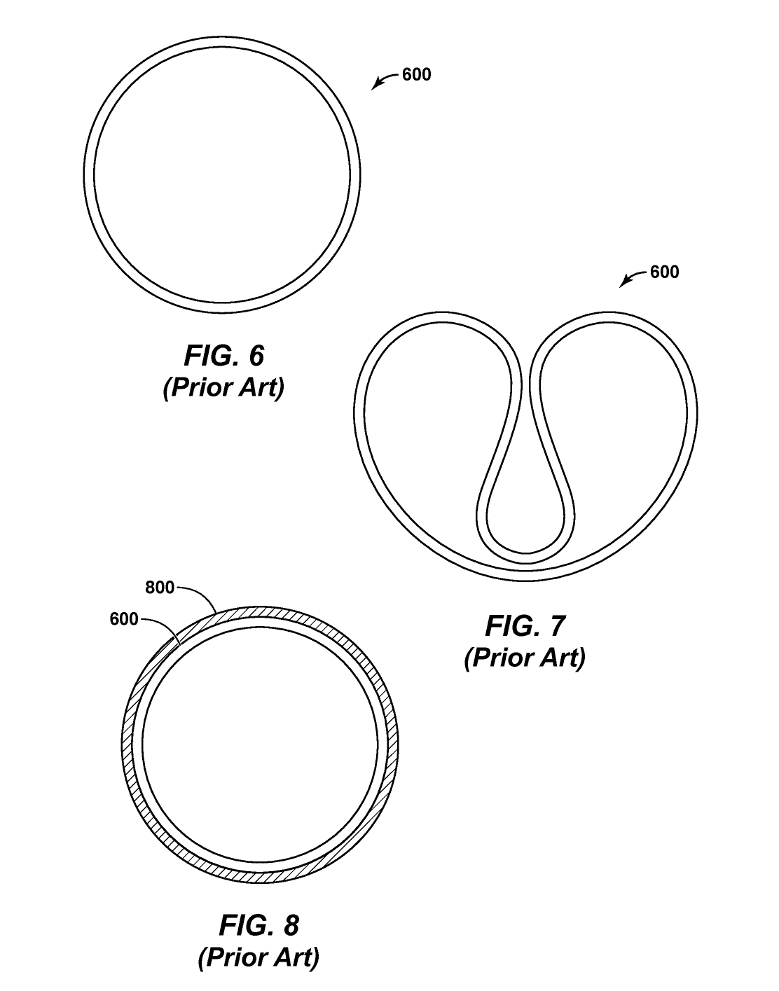

A much greater size reduction can be achieved by instead folding the liner into a U-shape. FIG. 6 is a cross-section of a typical pipeline liner 600 and FIG. 7 depicts liner 600 in a folded configuration as known in the prior art. The techniques and systems utilized to place the liner in a folded configuration are known and understood by those skilled in the art. FIG. 8 is a cross-section of a pipeline liner 600 and a host pipe 800 as known in the prior art. Once the folded liner 600 is properly positioned, the liner is returned to its original tubular shape by, in one example, pressurizing the internal volume. Again, the techniques and systems used to pressurize the liner are known and understood by those skilled in the art.

The axial reinforcements described herein may restrict the ability to elastically reduce the diameter of the pipeline liner. Folding would therefore become one desirable method for diameter reduction. However, a continuous layer of high-strength axial reinforcement could potentially restrict folding by limiting the amount of elastic hoop strain. In order to enable folding, one embodiment of the present disclosure is a pipeline liner in which the reinforcement structures are isolated to discrete regions of the liner circumference. Instead of a continuous layer, the axial reinforcements are supplied in the form of unique units, such as rods, cables, tapes, or strips, as illustrated in FIG. 5.

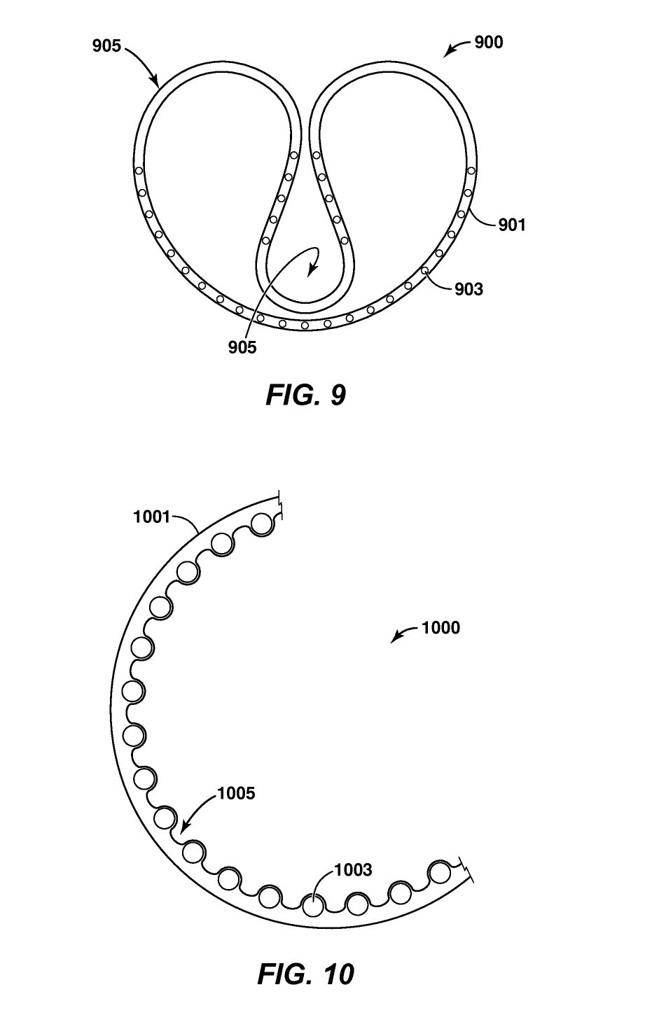

FIG. 9 is a cross-section of a pipeline liner 900 in a folded configuration according to one embodiment of the present disclosure. The pipeline liner 900 comprises a body portion 901. Reinforcement structures 903 are deployed at various points around the circumference of the body portion 901. In between the reinforcements 903 are regions of homogeneous thermoplastic material that composes the liner wall thickness. These regions provide elasticity to permit folding of the liner. The thermoplastic regions would also facilitate the tight-fitting condition by allowing some expansion of the liner when under pressure. In some embodiments, the axial reinforcements 903 are deployed in selective locations to further facilitate folding. As shown in FIG. 9, the liner 900 has areas or regions 905 which exhibit a large amount of bending when placed in a folded configuration. In the depicted embodiment, reinforcements 903 are not provided in areas designated by reference numeral 905 in order to allow liner 900 to sufficiently fold.

Another embodiment to assist liner folding and facilitate liner installation is to reduce the wall thickness in the thermoplastic regions. FIG. 10 is a partial cross-section of a pipeline liner 1000 according to one embodiment of the present disclosure. Liner 1000 comprises a body portion 1001 and reinforcements 1003 positioned at various points around the circumference of body 1001. In some embodiments, a full liner wall thickness is used to encapsulate the fiber reinforcements 1003. Because the reinforcements 1003 provide all of the pulling strength for installation, the interstitial thermoplastic regions are not required to have the full wall thickness. In addition, with the regions of axial reinforcement not contributing to the folding action, all of the bending strains are concentrated to the thermoplastic regions during the folding process.

The FIG. 10 embodiment demonstrates a concept in which a decreased thickness reduces the bending strain while permitting the appropriate amount of deflection. As depicted, a variety of areas with reduced wall thickness 1005 are provided around the circumference of body portion 1001. The ribbed or corrugated surface may be located on the internal surface as shown in FIG. 10. In other embodiments, the ribbed surface may be provided on the outer surface or both surfaces. An additional benefit is realized by the resulting weight reduction, potentially allowing longer installations.

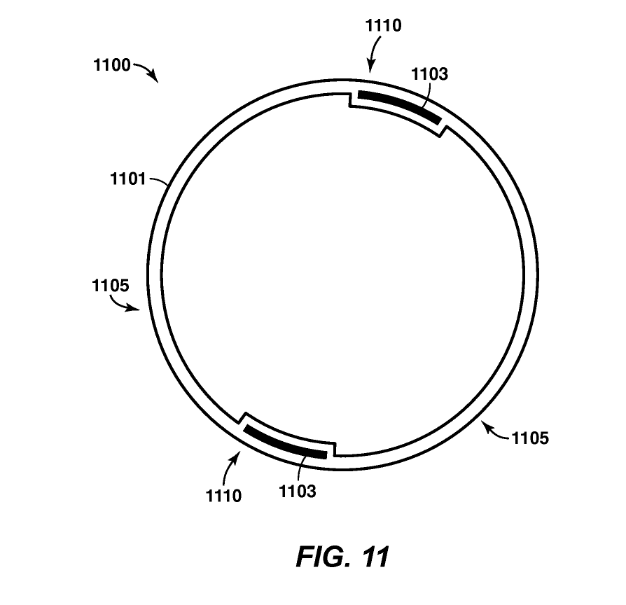

FIG. 11 is a cross-section of a pipeline liner 1100 according to one embodiment of the present disclosure. Liner 1100 comprises a body portion 1101 and two reinforcements 1103 positioned at various points around the circumference of the body portion 1101. Reinforcement structures 1103 are in the form of tape elements. In other embodiments, any suitable reinforcement structures as described herein may be utilized. The wall thickness of the body in areas 1110 that encapsulate or surround reinforcement structures 1103 is greater than the wall thickness of the body in areas 1105. Reinforcement structures 1103 are positioned radially adjacent the greater wall thickness in areas 1110. Areas 1105 in between reinforcement structures 1103 are of homogeneous thermoplastic material. Areas 1105 provide elasticity to permit folding of the liner and allow some expansion of the liner when under pressure to facilitate a tight-fit between the liner and the pipeline. As described herein, because the reinforcement structures provide the pulling strength for installation, the regions of the body in between the reinforcement structures are not required to have full wall thickness, providing for reduced bending strain while permitting an appropriate amount of deflection.

In addition, a manufacturing process according to embodiments of the present disclosure may provide the ability to produce a tubular composite with a thermoplastic matrix and longitudinal reinforcement. With respect to composite materials, the amount of strengthening provided by a reinforcing material is a function of the length of the reinforcing material. An exemplary manufacturing process facilitates the inclusion of reinforcing material in sufficiently long lengths to make hydrocarbon industry pipeline remediation feasible. Moreover, the manufacturing process does not break the fibers up into pieces so small that they provide relatively little in the way of strength reinforcement.

Embodiments of the present disclosure may be used to provide a pipeline liner having a relatively high ratio of desirable qualities to cost. Some techniques to maximize this ratio include the use of the most effective materials in the most efficient quantities. Thermoplastic matrix materials are available in many forms, with a variety of costs and strength properties. Because an exemplary pipeline liner according to embodiments of the present disclosure rely on the host pipeline for pressure containment, it may not be necessary to select a high-strength matrix that would incur greater costs. A simple and inexpensive thermoplastic like HDPE may be sufficient. Moreover, HDPE is known to be capable of maintaining pressure over small gaps or pores in the host pipeline. HDPE further serves as an excellent barrier to prevent internal pipeline corrosion.

Exemplary embodiments of the present disclosure combine a continuous manufacturing process with compatible materials. When a pipeline liner according to the present disclosure is manufactured in one continuous process, the materials used in the pipeline liner are desirably compatible with the manufacturing technique and able to provide the desired properties for installation and operation. Reinforcing material such as fibers are desirably selected to withstand the pulling forces for installation, while the thermoplastic matrix is chosen to serve as a sufficient barrier to corrosive fluids.

In order to manufacture pipeline liners having areas of reduced wall thickness, a variety of techniques may be utilized. In one embodiment, a die may be used which provides areas of reduced wall thickness within the liner as the liner is being extruded. In other embodiments, a milling process may be applied to an existing liner body to remove portions of the liner body. In yet another embodiment, removable portions may be initially embedded into the liner body which, when removed, result in areas within the liner body having a reduced thickness.

Disclosed aspects may be used in hydrocarbon management activities. As used herein, “hydrocarbon management” or “managing hydrocarbons” includes hydrocarbon extraction, hydrocarbon production, hydrocarbon exploration, identifying potential hydrocarbon resources, identifying well locations, determining well injection and/or extraction rates, identifying reservoir connectivity, acquiring, disposing of and/ or abandoning hydrocarbon resources, reviewing prior hydrocarbon management decisions, and any other hydrocarbon-related acts or activities. The term “hydrocarbon management” is also used for the injection or storage of hydrocarbons or CO₂, for example the sequestration of CO₂, such as reservoir evaluation, development planning, and reservoir management. In one embodiment, the disclosed methodologies, techniques and systems may be used to, directly or indirectly, extract hydrocarbons from a subsurface region. Hydrocarbon extraction may then be conducted to remove hydrocarbons from the subsurface region, which may be accomplished by drilling a well using oil drilling equipment. The equipment and techniques used to drill a well and/or extract the hydrocarbons are well known by those skilled in the relevant art. Other hydrocarbon extraction activities and, more generally, other hydrocarbon management activities, may be performed according to known principles.

It should be understood that the preceding is merely a detailed description of specific embodiments of this invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents. It is also contemplated that structures and features embodied in the present examples can be altered, rearranged, substituted, deleted, duplicated, combined, or added to each other. The articles “the”, “a” and “an” are not necessarily limited to mean only one, but rather are inclusive and open ended so as to include, optionally, multiple such elements.

What is claimed is:

1. A reinforced pipeline liner comprising:
a body portion having a layer of matrix material, the layer having an inner surface and an outer surface, wherein the body portion has a longitudinal dimension; and
a plurality of interspersed reinforcement structures embedded within the body portion, each reinforcement structure is positioned between the inner surface and outer surface of the layer and circumferentially offset from the other reinforcement structures, each reinforcement is aligned parallel to the longitudinal dimension.

2. The pipeline liner of claim 1, wherein the body portion has a plurality of areas in the body portion having a first wall thickness and a plurality of areas in the body portion having a second wall thickness, the first wall thickness is greater than the second wall thickness.

3. The pipeline liner of claim 2, wherein the inner surface is a corrugated surface.

4. The pipeline liner of claim 2, wherein the outer surface is a corrugated surface.

5. The pipeline liner of claim 2, wherein the inner surface and outer surface are corrugated surfaces.

6. The pipeline liner of claim 2, wherein the reinforcement structures are positioned radially adjacent to areas in the body portion having a first wall thickness.

7. The pipeline liner of claim 1, wherein the reinforcement structure is composed of a material is selected from a group consisting of glass, carbon, polymer fiber, metallic wire, and high-strength tapes.

8. A method for installing a liner within an existing pipe, the method comprising:
providing the liner comprising a body portion having a layer of matrix material, the layer having an inner surface and an outer surface, and a plurality of interspersed reinforcement structures embedded within the body portion, each reinforcement structure is positioned between the inner surface and outer surface of the layer and circumferentially offset from the other reinforcement structures, wherein the body portion has a longitudinal dimension and each reinforcement is aligned parallel to the longitudinal dimension, wherein the liner has an original cylindrical shape;
folding the liner;
pulling the folded liner through the existing pipe; and
returning the liner to the original cylindrical shape.

9. The method of claim 8, wherein the body portion has at least one area in the body portion having a first wall thickness and at least one area in the body portion having a second wall thickness, the first wall thickness is greater than the second wall thickness.

10. The method of claim 9, wherein the inner surface is a corrugated surface.

11. The method of claim 9, wherein the outer surface is a corrugated surface.

12. The method of claim 9, wherein the reinforcement structures are positioned radially adjacent to areas in the body portion having a first wall thickness.

13. The method of claim 8, wherein the reinforcement structure is composed of a material is selected from a group consisting of glass, carbon, polymer fiber, metallic wire, and high-strength tapes.

14. The method of claim 8, wherein the liner is returned to the original cylindrical shape by pressurizing the an internal cavity of the body portion.

15. A method for producing a liner for a pipe, the method comprising:
providing a material to form a body of the liner;
providing a material to form a reinforcement structure in the liner;
combining the material to form the body of the liner and the material to form the reinforcement structure in the liner, so that the body of the liner is produced with the reinforcement structure interspersed within the body of the liner; and
providing areas within the body of the liner having a first thickness in a radial direction and areas within the body of the liner having a second thickness in a radial direction, wherein the first thickness is greater than the second thickness.

16. The method of claim 15, wherein the areas having a second thickness are provided by a die.

17. The method of claim 15, wherein the areas having a second thickness are provided by a milling process.

18. The method recited in claim 15 further comprising providing strips of material on an external surface of the body of the liner, the strips of material are positioned parallel to a longitudinal dimension of the liner, wherein at least one of the areas of second thickness is provided by removing the strips of material from the body of the liner.
